(19) United States
(12) Patent Application Publication
(10) Pub. No.: US 2012/0185063 A1
(43) Pub. Date: Jul. 19, 2012

(54) Electronic control unit data recorder and code readable thereby

(75) Inventors: William Leisenring, Tecumseh, MI (US); Brandon Brigham, Clarkston, MI (US); Nathan Nantais, Windsor (CA); Naga Puttagunta, Ypsilanti, MI (US); Kenneth Raupp, Ann Arbor, MI (US)

(73) Assignee: CONTROL-TEC LLC, Allen Park, MI (US)

(21) Appl. No.: 13/134,660

(22) Filed: Jun. 14, 2011

Related U.S. Application Data
(60) Provisional application No. 61/461,538, filed on Jan. 18, 2011.

(51) Int. Cl. G06F 17/40; G05B 15/02

(52) U.S. Cl. 700/12

(57) ABSTRACT

Disclosed is electronic control unit data recorder readable code which is configured for storage in memory of an electronic control unit data recorder, such as a vehicle data recorder. The code is configured to provide that the electronic control unit data recorder has access to a plurality of configurations, receives data from at least one electronic control unit and uses at least a portion of the data to determine which configuration to use during data collection and processing. The configuration which the electronic control unit data recorder uses dictates what additional data is received from at least one electronic control unit by the electronic control unit data recorder, as well as what data regarding the electronic control unit is stored and/or transmitted by the electronic control unit data recorder.

### RELATED APPLICATION (PRIORITY CLAIM)

This application claims the benefit of United States Provisional Application Ser. No. 61/461,538, filed Jan. 18, 2011, which is hereby incorporated herein by reference in its entirety.

### REFERENCE TO COMPACT DISCS (CD-R'S) FILED WITH THE APPLICATION

Duplicate compact discs (CD-R's) have been filed with the present application as a computer program listing appendix. Each compact disc contains the following files: “seldloggerCode” (24 KB, created Jan. 14, 2011) and “uploadDataCode” (50 KB, created Jan. 14, 2011). The material on the compact discs is incorporated herein by reference as a computer program listing appendix.

### COPYRIGHT NOTICE

A portion of the disclosure of this patent application (including the files contained on the compact discs) contains material which is subject to copyright protection. The copyright owner has no objection to the facsimile reproduction by anyone of the patent document or the patent disclosure, as it appears in the United States Patent and Trademark Office patent file or records, but otherwise reserves all copyright rights whatsoever.

### BACKGROUND

The present invention generally relates to electronic control unit data recorders, such as vehicle data recorders.

A vehicle data recorder is a recording device which is present in a vehicle and which receives information from various electronic control units which are present in the vehicle. Each of the electronic control units controls one or more of the electrical systems or subsystems in the vehicle. Examples of some of the electronic control units which may be present in a vehicle include, but are not limited to, an airbag control unit, an engine control unit, a seat control unit, a speed control unit, and a transmission control unit. The vehicle data recorder receives information from the various electronic control units, and stores the information in memory and/or transmits the information wirelessly to a remote location. This information can be used for various purposes, for example to assess the function and performance of a pre-production or post-production vehicle, or to manage a fleet of vehicles.

A typical vehicle data recorder that is sufficiently intelligent to receive proprietary information from a vehicle is configured to only work with a specific vehicle configuration, such as a specific make and model of vehicle which has a certain engine and transmission, certain emission systems, as well as certain electronic control unit hardware/software configurations. Specifically, the vehicle data recorder has a configuration stored therein which dictates how the vehicle data recorder collects and processes data received from the electronic control units. The configuration which is stored in the vehicle data recorder is vehicle-specific. Therefore, to manage a fleet of vehicles, where the fleet includes vehicles of various configurations such as various makes and models of vehicles, one must employ a plurality of different vehicle data recorders.

### SUMMARY

The present invention is directed at providing an electronic control unit data recorder which is automated and efficient. Specifically, an embodiment of the present invention provides an electronic control unit data recorder, such as a vehicle data recorder, which is configured to work with a plurality of different vehicles. One embodiment of the present invention provides code which is readable by an electronic control unit data recorder, wherein the code is configured to provide that the electronic control unit data recorder stores a plurality of configurations in memory, receives data from at least one electronic control unit, and uses at least a portion of the data to determine which configuration stored in memory to use during data collection and processing. The configuration which the electronic control unit data recorder uses dictates what additional data is received from at least one electronic control unit, as well as what data regarding the electronic control unit is stored and/or transmitted by the electronic control unit data recorder.

### BRIEF DESCRIPTION OF THE DRAWINGS

The organization and manner of the structure and operation of the invention, together with further objects and advantages thereof, may best be understood by reference to the following description taken in connection with the accompanying drawings wherein like reference numerals identify like elements in which:

FIG. 1 is a block diagram of a fleet management system which employs a plurality of electronic control unit data recorders, each of which is in accordance with an embodiment of the present invention;

FIG. 2 provides a high level diagram of each of the electronic control unit data recorders shown in FIG. 1; and

FIGS. 3-5 provide flowcharts regarding the automated configuration deployment, management, selection, error-handling and configuring of each of the electronic control unit data recorders shown in FIG. 1.

### DETAILED DESCRIPTION OF AN ILLUSTRATED EMBODIMENT

While this invention may be susceptible to embodiment in different forms, there is shown in the drawings and will be described herein in detail, a specific embodiment with the understanding that the present disclosure is to be considered an exemplification of the principles of the invention, and is not intended to limit the invention to that as illustrated.

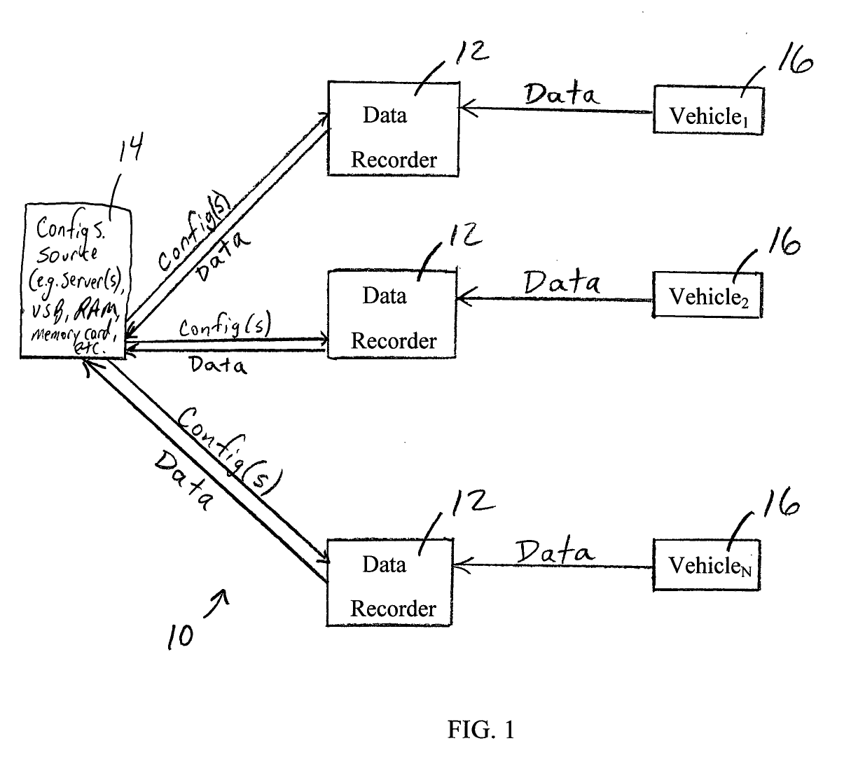

FIG. 1 illustrates a fleet management system 10 which employs a plurality of electronic control unit data recorders 12, wherein each of the electronic control unit data recorders 12 is identical and in accordance with an embodiment of the present invention. Each of the electronic control unit data recorders 12 contains code in its memory which provides, as shown in FIG. 1, that the electronic control unit data recorder 12 receives a plurality of configurations from one or more servers 14 and stores the configurations in memory. Each of the configurations which is received and stored in the memory of the electronic control unit data recorder 12 relates to, for example, a different vehicle configuration, wherein the configuration is specific with regard to several factors, such as the make of the vehicle, the exact level of model year, as well as the exact engine, transmission, emission systems, and electronic control unit hardware/software, etc. embodied in the vehicle.

The code stored in the memory of the electronic control unit data recorder 12 provides that thereafter the electronic control unit data recorder 12 can be interfaced with a vehicle 16 (in FIG. 1, the vehicles 16 are identified with “Vehicle₁”, “Vehicle₂”, . . . “Vehicle_{N}”, thereby indicating that each of the vehicles can be of a different configuration (i.e., a different configuration with regard to the make of the vehicle, the exact level of model year, as well as the exact engine, transmission, emission systems, and electronic control unit hardware/software, etc. embodied in the vehicle), and the electronic control unit data recorder 12 receives information from the vehicle 16 which allows the electronic control unit data recorder 12 to identify the exact configuration of the vehicle 16. Based on the identification, the electronic control unit data recorder 12 effectively selects one of the configurations stored in memory to use in connection with data collection and processing vis-à-vis the electronic control units of the vehicle 16. The electronic control unit data recorder 12 may also store in memory a default configuration which can be used whenever the electronic control unit data recorder 12 is unable to identify the exact configuration of a given vehicle.

Alternatively, the code stored in the memory of the electronic control unit data recorder 12 can be configured such that the electronic control unit data recorder 12 receives information from the vehicle 16 which allows the electronic control unit data recorder 12 to identify the exact configuration of the vehicle 16 and then based on the identification, the electronic control unit data recorder 12 retrieves the correct configuration from the one or more servers 14 and stores the configuration in memory for subsequent use in connection with data collection and processing vis-à-vis the electronic control units of the vehicle 16.

Still further, instead of having to obtain one or more configurations from a remote location such as from one or more servers 14, a plurality of configurations may be pre-stored in the memory of the electronic control unit data recorder 12. As such, as shown in FIG. 1, reference numeral 14 can refer to any appropriate source for the configurations, such as one or more remote servers, a USB port on the electronic control unit data recorder 12, RAM of the electronic control unit data recorder 12, a memory card (such as an SD card) of the electronic control unit data recorder 12, etc. Regardless, preferably thereafter the electronic control unit data recorder 12 receives information from the vehicle 16 which allows the electronic control unit data recorder 12 to identify the exact configuration of the vehicle 16. Based on the identification, the electronic control unit data recorder 12 subsequently uses the correct configuration in connection with data collection and processing vis-à-vis the electronic control units of the vehicle 16.

Regardless, the code stored in the memory of the electronic control unit data recorder 12 provides that once the electronic control unit data recorder 12 selects a configuration, the electronic control unit data recorder 12 thereafter collects data from various electronic control units and processes the data pursuant to the configuration. The configuration also dictates what data is stored by the electronic control unit data recorder 12, as well as also possibly what data is transmitted by the electronic control unit data recorder 12 to a remote location.

Preferably, the code stored in the memory of the electronic control unit data recorder 12 provides that the electronic control unit data recorder can communicate with the server(s) 14 and dynamically update at least one of its stored configurations, thereby providing an electronic control unit data recorder 12 having a dynamic configuration.

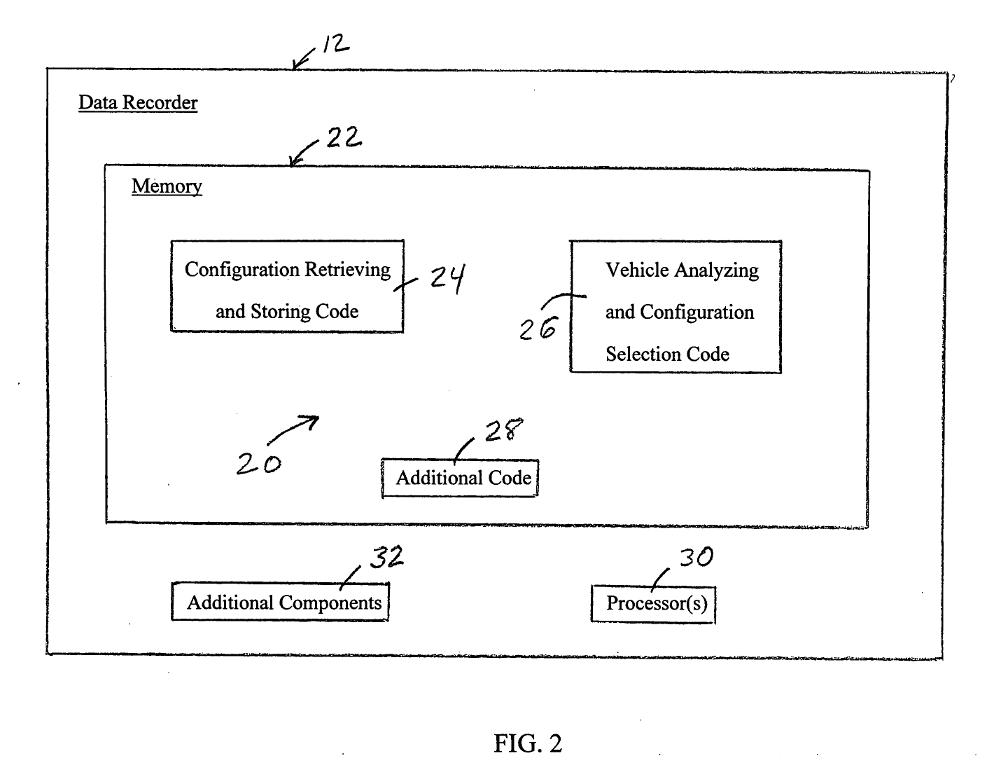

FIG. 2 provides a high level diagram of the electronic control unit data recorder 12, including the code 20 which is stored in the memory 22 of the electronic control unit data recorder 12, wherein the code is in accordance with a preferred embodiment of the present invention with other embodiments being entirely possible. As shown, a preferred embodiment of the present invention provides that the code 20 which is stored in memory 22 preferably includes configuration retrieving and storing code 24, which provides that the electronic control unit data recorder 12 receives a plurality of configurations from one or more servers 14 (see FIG. 1) and stores the configurations in memory 22. As shown, the code 20 which is stored in memory 22 also preferably includes vehicle analyzing and configuration selection code 26, which provides that the electronic control unit data recorder 12 receives information from a vehicle 16 (see FIG. 1) which allows the electronic control unit data recorder 12 to identify the exact configuration of the vehicle 16. Thereafter, based on the identification, the electronic control unit data recorder 12 effectively selects one of the configurations stored in memory 22 to use in connection with data collection and processing vis-à-vis the electronic control units of the vehicle 16. As shown, the code which is stored in memory also preferably includes additional code 28, including data acquisition code, which additionally dictates and controls the operation and functionality of the electronic control unit data recorder 12. As shown in FIG. 2, in addition to the memory 22 and code 20 stored therein, the electronic control unit data recorder 12 also includes one or more processors 30 as well as additional components 32 which are relevant to the operation and functionality of the electronic control unit data recorder 12.

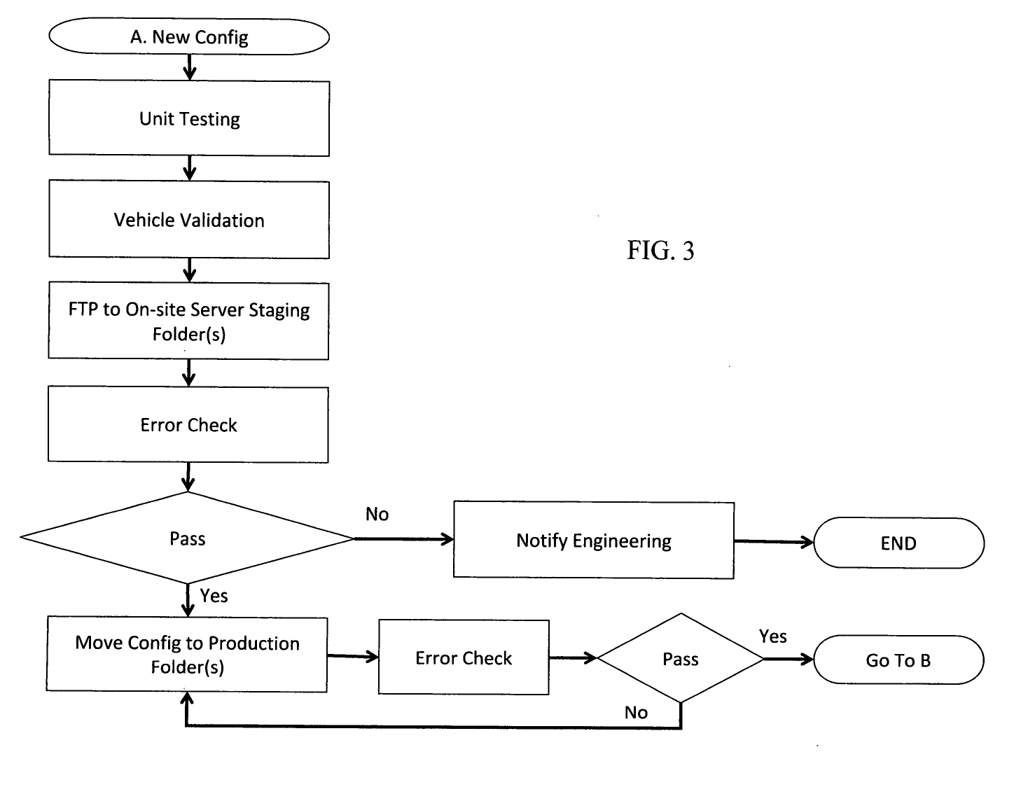

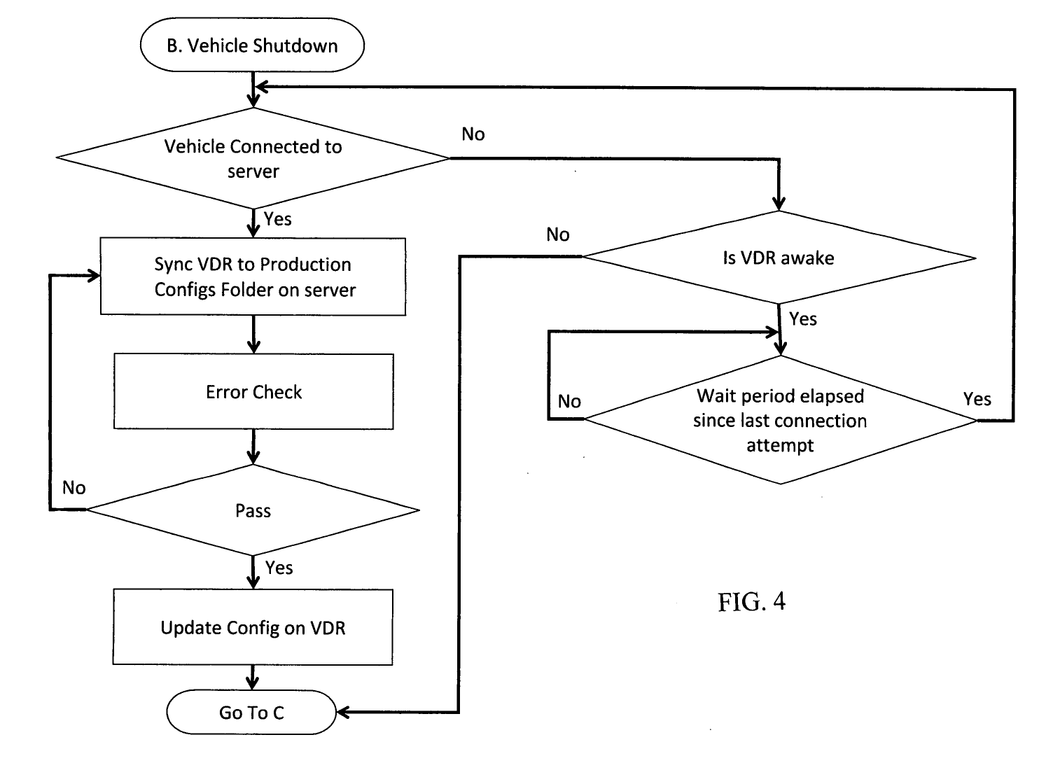

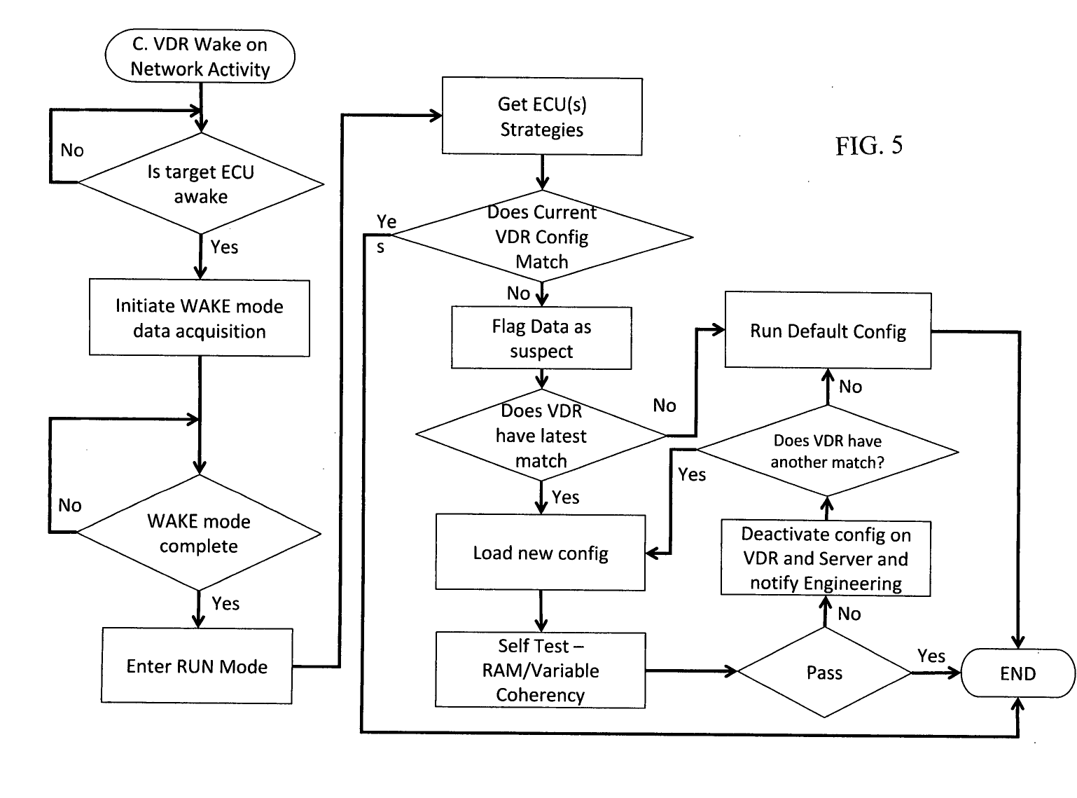

FIGS. 3-5 provide flowcharts regarding the automated configuration deployment, management, selection, error-handling and configuring of the electronic control unit data recorder 12 (and each of the electronic control unit data recorders 12 shown in FIG. 1), and are self-explanatory.

The code which is included on the compact discs which have been deposited with the United States Patent and Trademark Office and filed with this application corresponds to the configuration retrieving and storing code 24 and configuration selection code 26 which has been described hereinabove.

While the present disclosure specifically discusses a vehicle data recorder as being the type of electronic control unit data recorder with which the present invention is utilized, the present invention can be implemented in many other types of devices and systems. For example, the present invention can be used to manage a fleet of boats, a plurality of bridges, or really anything which is capable of being monitored and/or controlled by one or more electronic control units.

While a specific embodiment of the present invention is shown and described, it is envisioned that those skilled in the art may devise various modifications without departing from the spirit and scope of the present invention.

What is claimed is:

1. Code which is readable by an electronic control unit data recorder, wherein the electronic control unit data recorder is configured to receive data from at least one electronic control unit, wherein the code is configured to provide that the electronic control unit data recorder has access to a plurality of configurations, receives data from at least one electronic control unit, and uses at least a portion of the data to determine which configuration to use during data collection and processing, wherein the configuration which the electronic control unit data recorder uses dictates what additional data is received from at least one electronic control unit, as well as what data regarding the electronic control unit is at least one of stored and transmitted by the electronic control unit data recorder.

2. Code as recited in claim 1, wherein the code is configured such that the electronic control unit data recorder receives a plurality of configurations from at least one server and stores the configurations in memory of the electronic control unit data recorder.

3. Code as recited in claim 2, wherein each of the configurations which is received and stored in the memory of the electronic control unit data recorder relates to a different electronic control unit configuration.

4. Code as recited in claim 3, wherein the code stored in the memory of the electronic control unit data recorder provides that the electronic control unit data recorder is interfaceable with a system of electronic control units, and wherein the code stored in the memory of the electronic control unit data recorder provides that the electronic control unit data recorder receives information from the system which allows the electronic control unit data recorder to identify the exact configuration of the system, whereafter based on the identification, the electronic control unit data recorder selects one of the configurations stored in memory to use in connection with data collection and processing vis-à-vis the electronic control units of the system.

5. Code as recited in claim 4, wherein the code is configured such that the electronic control unit data recorder stores in memory a default configuration which is useable whenever the electronic control unit data recorder is unable to identify the exact configuration of a given system or whenever no matching configuration is available for use by the electronic control unit data recorder.

6. Code as recited in claim 4, wherein the code is configured such that the electronic control unit data recorder is configurable to receive information from the system which allows the electronic control unit data recorder to identify the exact configuration of the system and then based on the identification, the electronic control unit data recorder retrieves the correct configuration from at least one server and stores the configuration in memory for subsequent use in connection with data collection and processing vis-à-vis the electronic control units of the system.

7. Code as recited in claim 4, wherein a plurality of configurations are pre-stored in the memory of the electronic control unit data recorder, and wherein the code is configured such that the electronic control unit data recorder receives information from the system which allows the electronic control unit data recorder to identify the exact configuration of the system, whereafter based on the identification, the electronic control unit data recorder subsequently uses the correct configuration in connection with data collection and processing vis-à-vis the electronic control units of the system.

8. Code as recited in claim 4, wherein the code is configured to provide that once the electronic control unit data recorder selects a configuration, the electronic control unit data recorder thereafter collects data from various electronic control units and processes the data pursuant to the configuration, wherein the configuration also dictates what data is stored by the electronic control unit data recorder, as well as what data is transmitted by the electronic control unit data recorder to a remote location.

9. Code as recited in claim 4, wherein the code is configured to provide that the electronic control unit data recorder can communicate with at least one server and dynamically update at least one of its stored configurations, thereby providing an electronic control unit data recorder having a dynamic configuration.

10. Code as recited in claim 4, wherein the code comprises configuration retrieving and storing code, wherein the configuration retrieving and storing code is configured to provide that the electronic control unit data recorder receives a plurality of configurations from at least one server and stores the configurations in memory.

11. Code as recited in claim 4, wherein the code comprises electronic control unit system analyzing and configuration selection code, wherein the electronic control unit system analyzing and configuration selection code is configured to provide that the electronic control unit data recorder receives information from an electronic control unit system which allows the electronic control unit data recorder to identify the exact configuration of the electronic control unit system, wherein thereafter, based on the identification, the electronic control unit data recorder selects one of the configurations stored in memory to use in connection with data collection and processing vis-à-vis the electronic control units of the system.

12. An electronic control unit data recorder comprising code stored in memory, wherein the electronic control unit data recorder is configured to receive data from at least one electronic control unit, wherein the code is configured to provide that the electronic control unit data recorder stores a plurality of configurations in memory, receives data from at least one electronic control unit, and uses at least a portion of the data to determine which configuration stored in memory to use during data collection and processing, wherein the configuration which the electronic control unit data recorder uses dictates what additional data is received from at least one electronic control unit, as well as what data regarding the electronic control unit is stored and/or transmitted by the electronic control unit data recorder.

13. An electronic control unit data recorder as recited in claim 12, wherein the electronic control unit data recorder is configured to receive a plurality of configurations from at least one server and store the configurations in memory.

14. An electronic control unit data recorder as recited in claim 13, wherein each of the configurations which is received and stored in the memory of the electronic control unit data recorder relates to a different electronic control unit system configuration.

15. An electronic control unit data recorder as recited in claim 14, wherein the electronic control unit data recorder is configured to interface with an electronic control unit system, and wherein electronic control unit data recorder receives information from the system which allows the electronic control unit data recorder to identify the exact configuration of the system, whereafter based on the identification, the electronic control unit data recorder selects one of the configurations stored in memory to use in connection with data collection and processing vis-à-vis the system.

16. An electronic control unit data recorder as recited in claim 15, wherein a default configuration is stored in the memory of the electronic control unit data recorder, wherein the default configuration is useable whenever the electronic control unit data recorder is unable to identify the exact configuration of a given system or whenever no matching configuration is available for use by the electronic control unit data recorder.

17. An electronic control unit data recorder as recited in claim 15, wherein the electronic control unit data recorder is configurable to receive information from the system which allows the electronic control unit data recorder to identify the exact configuration of the system and then based on the identification, the electronic control unit data recorder retrieves the correct configuration from at least one server and stores the configuration in memory for subsequent use in connection with data collection and processing vis-à-vis the system.

18. An electronic control unit data recorder as recited in claim 15, wherein a plurality of configurations are pre-stored in the memory of the electronic control unit data recorder, and wherein the electronic control unit data recorder is configured to receive information from the system which allows the electronic control unit data recorder to identify the exact configuration of the system, whereafter based on the identification, the electronic control unit data recorder subsequently uses the correct configuration in connection with data collection and processing vis-à-vis the system.

19. An electronic control unit data recorder as recited in claim 15, wherein the electronic control unit data recorder is configured to select a configuration, the electronic control unit data recorder thereafter collects data from various electronic control units of the system and processes the data pursuant to the configuration, wherein the configuration also dictates what data is stored by the electronic control unit data recorder, as well as what data is transmitted by the electronic control unit data recorder to a remote location.

20. An electronic control unit data recorder as recited in claim 15, wherein the electronic control unit data recorder is configured to communicate with the at least one server and dynamically update at least one of its stored configurations, thereby providing an electronic control unit data recorder having a dynamic configuration.

21. An electronic control unit data recorder as recited in claim 15, wherein the electronic control unit data recorder is configured to receive a plurality of configurations from at least one server and store the configurations in memory.

22. An electronic control unit data recorder as recited in claim 15, wherein the electronic control unit data recorder is configured to receive information from the system which allows the electronic control unit data recorder to identify the exact configuration of the system, wherein thereafter, based on the identification, the electronic control unit data recorder selects one of the configurations stored in memory to use in connection with data collection and processing vis-à-vis the system.

23. A system comprising a plurality of electronic control unit data recorders, wherein each electronic control unit data recorder comprises code stored in memory, wherein each electronic control unit data recorder is configured to receive data from at least one electronic control unit, wherein the code is configured to provide that the electronic control unit data recorder has access to a plurality of configurations, receives data from at least one electronic control unit, and uses at least a portion of the data to determine which configuration to use during data collection and processing, wherein the configuration which the electronic control unit data recorder uses dictates what additional data is received from at least one electronic control unit, as well as what data regarding the electronic control unit is stored and/or transmitted by the electronic control unit data recorder.

24. A system as recited in claim 23, wherein each electronic control unit data recorder is configured to receive a plurality of configurations from at least one server and store the configurations in memory.

25. A system as recited in claim 24, wherein each of the configurations which is received and stored in the memory of at least one of the electronic control unit data recorders relates to a different electronic control unit system configuration.

26. A system as recited in claim 25, wherein each electronic control unit data recorder is configured to interface with an electronic control unit system, and wherein each electronic control unit data recorder receives information from the electronic control unit system which allows the electronic control unit data recorder to identify the exact configuration of the electronic control unit system, whereafter based on the identification, the electronic control unit data recorder selects one of the configurations stored in memory to use in connection with data collection and processing vis-à-vis the electronic control unit system.

27. A system as recited in claim 26, wherein a default configuration is stored in the memory of each electronic control unit data recorder, wherein the default configuration is useable whenever the electronic control unit data recorder is unable to identify the exact configuration of a given electronic control unit system or whenever no matching configuration is available for use by the electronic control unit data recorder.

28. A system as recited in claim 26, wherein each electronic control unit data recorder is configurable to receive information from the electronic control unit system which allows the electronic control unit data recorder to identify the exact configuration of the electronic control unit system and then based on the identification, the electronic control unit data recorder retrieves the correct configuration from at least one server and stores the configuration in memory for subsequent use in connection with data collection and processing vis-à-vis the electronic control unit system.

29. A system as recited in claim 26, wherein a plurality of configurations are pre-stored in the memory of each electronic control unit data recorder, and wherein each electronic control unit data recorder is configured to receive information from the electronic control unit system which allows the electronic control unit data recorder to identify the exact configuration of the electronic control unit system, whereafter based on the identification, the electronic control unit data recorder subsequently uses the correct configuration in connection with data collection and processing vis-à-vis the electronic control unit system.

30. A system as recited in claim 26, wherein each electronic control unit data recorder is configured to select a configuration, wherein the electronic control unit data recorder thereafter collects data from various electronic control units and processes the data pursuant to the configuration, wherein the configuration also dictates what data is stored by the electronic control unit data recorder, as well as what data is transmitted by the electronic control unit data recorder to a remote location.

31. A system as recited in claim 26, wherein each electronic control unit data recorder is configured to communicate with the at least one server and dynamically update at least one of its stored configurations, thereby providing that each electronic control unit data recorder has a dynamic configuration.

32. A system as recited in claim 26, wherein each electronic control unit data recorder is configured to receive a plurality of configurations from at least one server and store the configurations in memory.

33. A system as recited in claim 26, wherein each electronic control unit data recorder is configured to receive information from an electronic control unit system which allows the electronic control unit data recorder to identify the exact configuration of the electronic control unit system, wherein thereafter, based on the identification, the electronic control unit data recorder selects one of the configurations stored in memory to use in connection with data collection and processing vis-à-vis the electronic control unit system.
